(19) United States
(12) Patent Application Publication
(10) Pub. No.: US 2016/0099083 A1
(43) Pub. Date: Apr. 7, 2016

(54) FAST FLUX SHIELD AND METHOD OF REDUCING FAST NEUTRON FLUENCE AT A CORE SHROUD OF A BOILING WATER REACTOR USING THE SAME

(71) Applicants: John Christopher HANNAH, Wilmington, NC (US); Russell Edward STACHOWSKI, Wilmington, NC (US); John Patrick REA, Wilmington, NC (US); Paul Everett CANTONWINE, Wilmington, NC (US)

(72) Inventors: John Christopher HANNAH, Wilmington, NC (US); Russell Edward STACHOWSKI, Wilmington, NC (US); John Patrick REA, Wilmington, NC (US); Paul Everett CANTONWINE, Wilmington, NC (US)

(73) Assignee: GE-Hitachi Nuclear Energy Americas LLC, Wilmington, NC (US)

(21) Appl. No.: 14/503,755

(22) Filed: Oct. 1, 2014

(51) Int. Cl. G21C 11/06

(52) U.S. Cl. CPC G21C 11/06

(57) ABSTRACT

A boiling water reactor core according to an example embodiment may include a core shroud and a plurality of fuel bundles within the core shroud. A plurality of shielding bundles are arranged as a fast flux shield between the plurality of fuel bundles and the core shroud. The plurality of shielding bundles include a metal hydride as a neutron moderator.

### BACKGROUND

1. Field

The present disclosure relates to neutron shielding in a nuclear reactor.

2. Description of Related Art

Conventionally, fast neutrons are produced by fission reactions in a nuclear reactor. A fast neutron is a free neutron with a kinetic energy level of about 1 MeV or more. Over time, various structures within a nuclear reactor may be degraded by fast neutron irradiation, thereby shortening the life of those components and requiring mitigating action to continue operation of the nuclear power plant. To extend the life of a nuclear power plant, the fast neutrons which cause the most significant irradiation damage may be converted to lower-energy thermal neutrons via a process called thermalization. In a conventional nuclear power plant, water has been used as a neutron moderator to slow down (thermalize) the fast neutrons.

### SUMMARY

A boiling water reactor core according to an example embodiment may include a core shroud; a plurality of fuel bundles within the core shroud; and a plurality of shielding bundles between the plurality of fuel bundles and the core shroud. The plurality of shielding bundles include a metal hydride as a neutron moderator.

Example embodiments also relate to a method of reducing fast neutron fluence at a core shroud of a boiling water reactor. The method may include surrounding a plurality of fuel bundles within the core shroud with a plurality of shielding bundles. The plurality of shielding bundles include a metal hydride as a neutron moderator.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a partial schematic view of a core of a boiling water reactor with shielding structures according to an example embodiment.

FIG. 2 is a partial schematic view of a core of a boiling water reactor with shielding structures according to another example embodiment.

FIG. 3 is a graph of the relative flux of a conventional core and a core with shielding structures according to an example embodiment.

### DETAILED DESCRIPTION

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

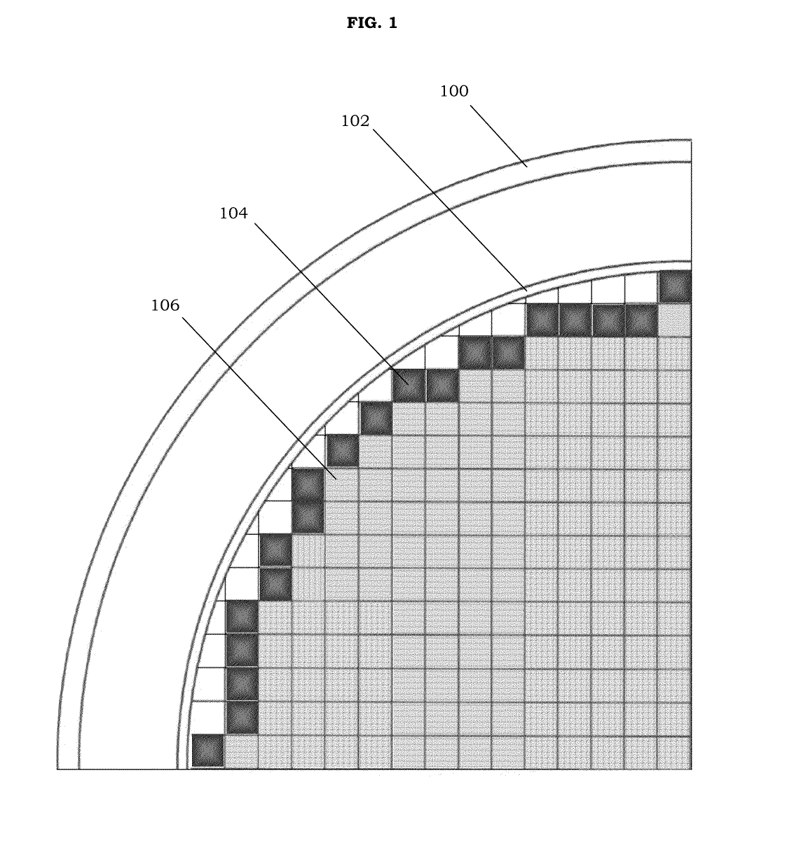

FIG. 1 is a partial schematic view of a core of a boiling water reactor with shielding structures according to an example embodiment. Referring to FIG. 1, the core is contained within a reactor pressure vessel 100 of a boiling water reactor. The core is the heat source for steam generation for the boiling water reactor. The reactor pressure vessel 100 contains the heat as well as the steam and fission products generated therein. The boiling water reactor core includes a core shroud 102 and a plurality of shielding bundles 104 and fuel bundles 106 within the core shroud 102. The plurality of fuel bundles 106 may include uranium dioxide as the nuclear fuel. The reactor pressure vessel 100 and the core shroud 102 define an annular space (e.g., downcomer region) therebetween. Generally, during the operation of the boiling water reactor, steam rises upward through the core shroud 102 (amongst the plurality of shielding bundles 104 and fuel bundles 106 therein), while liquid water flows downward through the annular space between the reactor pressure vessel 100 and the core shroud 102.

Each of the plurality of fuel bundles 106 may have a standard configuration that includes a channel that houses a plurality of fuel rods therein. The plurality of fuel rods within the channel may be secured at their upper ends by an upper tie plate, secured at their lower ends by a lower tie plate, and/or supported in their middle regions by a spacer. When arranged within the core shroud 102, the plurality of fuel bundles 106 may be supported from below by a fuel support piece and secured from above by a top guide.

The plurality of fuel bundles 106 and the plurality of shielding bundles 104 are arranged in an array within the core shroud 102. The array may be a regular arrangement of the structures into orderly rows and columns. As shown in FIG. 1, the array may be configured to maximize the utilized space within the core shroud 102, although example embodiments are not limited thereto. To protect the core shroud 102 from fast neutrons generated from the fission reactions of the core, the plurality of shielding bundles 104 are positioned between the plurality of fuel bundles 106 and the core shroud 102. The plurality of shielding bundles 104 include a metal hydride as a neutron moderator. A metal hydride with a relatively high hydrogen content (e.g., two or more hydrogen atoms per metal atom) may be particularly beneficial as a neutron moderator. In particular, the metal hydride may be a transition metal hydride. Additionally, the transition metal hydride may be a Group 4 metal hydride. Furthermore, the Group 4 metal hydride may be zirconium hydride or titanium hydride.

In an example embodiment, the plurality of shielding bundles 104 are peripheral constituents of the array of bundles within the core shroud 102. For instance, the peripheral constituents may be outermost components of the array that are closest to the core shroud 102. Although FIG. 1 shows that all of the outermost components of the array are shielding bundles 104, it should be understood that only the structures within a predetermined or desired distance to the core shroud 102 may need to be shielding bundles 104. Stated more clearly, an outermost component of the array may not need to be a shielding bundle 104 if such a component is not deemed sufficiently close to the core shroud 102.

To obtain the configuration of FIG. 1, the original outermost fuel bundles within the core shroud 102 may be modified to obtain the shielding bundles 104. In particular, the nuclear fuel within the fuel rods of the original outermost fuel bundles may be replaced with a neutron moderator (e.g., metal hydride). The replacement may be partial or complete. Stated more clearly, in a partial replacement example, only a portion (e.g., two rows) of the fuel rods closest to the core shroud 102 in the original outermost fuel bundles may have their nuclear fuel replaced with a neutron moderator. On the other hand, in a complete replacement example, all of the fuel rods in the original outermost fuel bundles closest to the core shroud 102 may have their nuclear fuel replaced with a neutron moderator. Thus, the shielding bundles 104 may structurally resemble the fuel bundles 106 but differ in that the shielding bundles 104 contain a neutron moderator while the fuel bundles 106 include nuclear fuel. As a result, each of the plurality of shielding bundles 104 may include a plurality of shielding tubes containing a neutron moderator (e.g., metal hydride), and the plurality of shielding tubes may have a same diameter as a plurality of fuel tubes containing the nuclear fuel in the plurality of fuel bundles 106. The height of the shielding bundles 104 may also be the same as the height of the fuel bundles 106, although example embodiments are not limited thereto. Furthermore, like the plurality of fuel bundles 106, the plurality of shielding bundles 104 may be supported from below by a fuel support piece and secured from above by a top guide.

Alternatively, the plurality of shielding bundles 104 may be in the form of other containers that house the neutron moderator (e.g., metal hydride). Such containers may have a variety of shapes and sizes. The plurality of shielding bundles 104 may include (or be in the form of) a water-proof sheath that surrounds the neutron moderator (e.g., metal hydride). To implement, the plurality of shielding bundles 104 may be inserted to replace the original outermost fuel bundles within the core shroud 102. However, it should be understood that if space permits within the core, the plurality of shielding bundles 104 may be inserted to surround (without displacing or replacing) the plurality of fuel bundles 106 already present within the core shroud 102. The alternative shapes and/or sizes of the shielding containers may also be structured and/or augmented such that the plurality of shielding bundles 104 may be supported from below by a core plate and secured from above by a top guide.

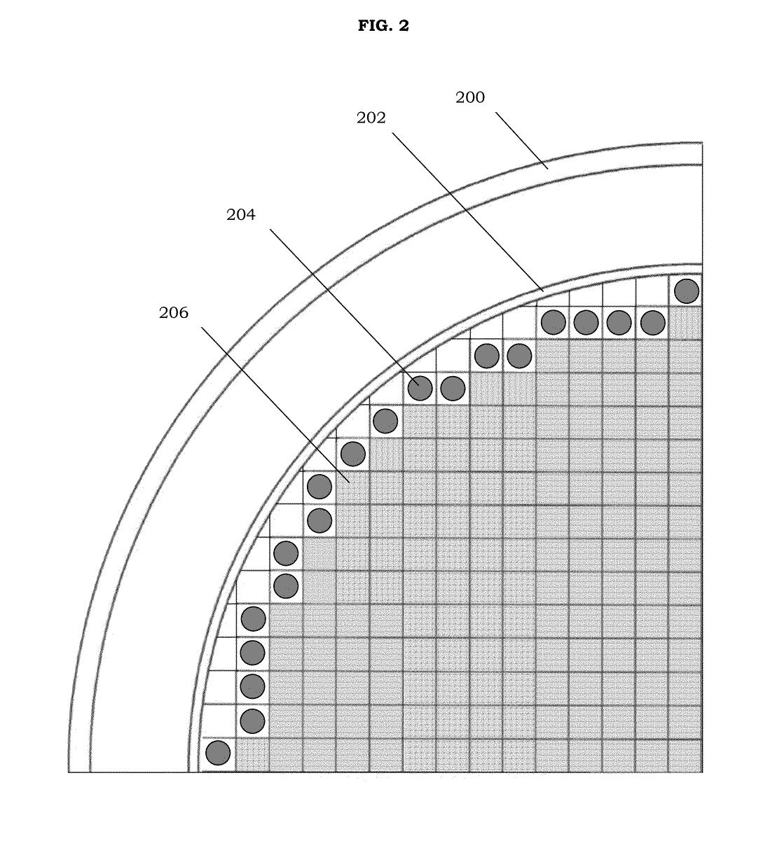

FIG. 2 is a partial schematic view of a core of a boiling water reactor with shielding structures according to another example embodiment. Referring to FIG. 2, the core is contained within a reactor pressure vessel 200 of a boiling water reactor. The boiling water reactor core includes a core shroud 202 and a plurality of shielding bundles 204 and fuel bundles 206 within the core shroud 202. The reactor pressure vessel 200, core shroud 202, and fuel bundles 206 may be as described in connection with FIG. 1.

In FIG. 2, each of the plurality of shielding bundles 204 is in a form of a single rod containing the neutron moderator (e.g., metal hydride). Although the single rod is shown as being in a cylindrical shape, it should be understood that other shapes are also possible. Because of the single rod form, each of the plurality of shielding bundles 204 may have a greater diameter than each of a plurality of fuel tubes containing nuclear fuel in the plurality of fuel bundles 206. Additionally, while the neutron shield is shown as being one shielding bundle 204 thick in FIG. 2 (and similarly shown in FIG. 1), it should be understood that the thickness may be increased to two or more layers of shielding bundles 204. When a greater number of shielding bundles 204 are included within the core shroud 202, it should be understood that a corresponding number of fuel bundles 206 may need to be removed and/or displaced to accommodate the additional shielding bundles 204. Furthermore, the plurality of shielding bundles 204 and the plurality of fuel bundles 206 may be supported from below by a fuel support piece and secured from above by a top guide. In lieu of (or in addition to) the example embodiments shown in FIGS. 1-2, a shielding structure may also be formed as a shielding layer on the inner surface of the core shroud 102.

As discussed above, a core may be modified in such a way so as to reduce the fast neutron fluence at a core shroud of a boiling water reactor. The method of reducing fast neutron fluence may include surrounding a plurality of fuel bundles within the core shroud with a plurality of shielding bundles. The plurality of shielding bundles include a metal hydride as a neutron moderator. The metal hydride may be zirconium hydride, although example embodiments are not limited thereto. The surrounding step may include inserting the plurality of shielding bundles between the core shroud and the plurality of fuel bundles. In particular, the plurality of fuel bundles may be arranged in an array within the core shroud, and the surrounding step may include replacing the peripheral bundles of the plurality of fuel bundles with the plurality of shielding bundles. The plurality of shielding bundles may be in a variety of forms, shapes, and sizes, provided that it can adequately contain the neutron moderator therein. Alternatively, the surrounding step may include just replacing (partially or completely) the nuclear fuel in the peripheral bundles of the plurality of fuel bundles with the metal hydride so as to convert the peripheral structures into shielding bundles. The plurality of shielding bundles may be positioned as outermost constituents of the array. As a result, the plurality of shielding bundles may be closer to the core shroud than any of the plurality of fuel bundles. In an example embodiment, the plurality of shielding bundles also do not contact the core shroud. In view of the implementation of the plurality of shielding bundles, the core shroud is shielded from fast neutrons originating from the plurality of fuel bundles. Notably, the neutron moderator within the plurality of shielding bundles helps to convert the fast neutrons into lower-energy thermal neutrons, thereby protecting structures such as the core shroud from degradation and premature failure.

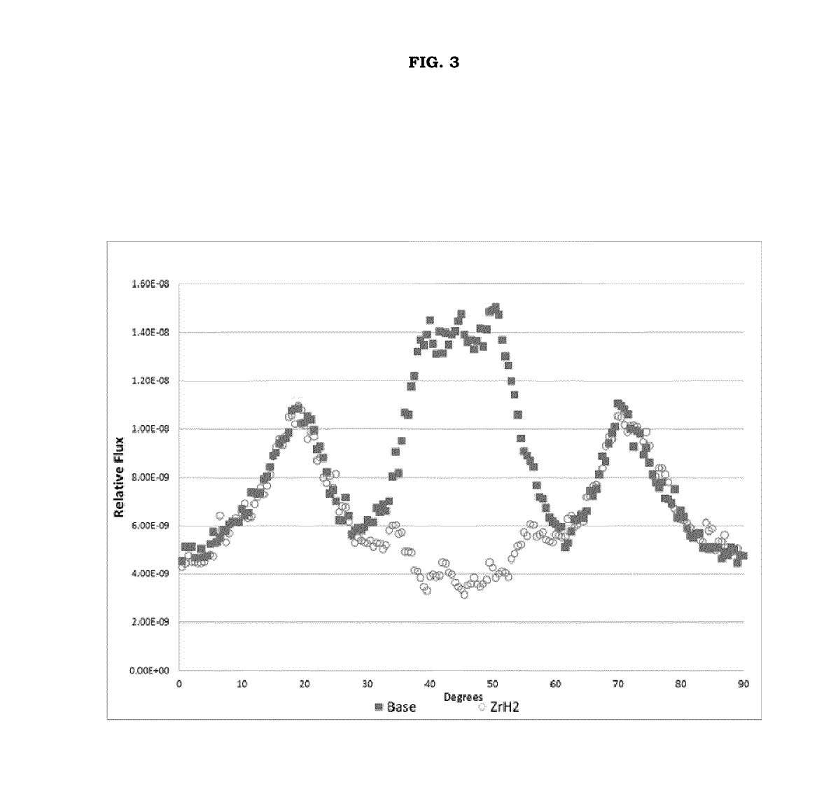

FIG. 3 is a graph of the relative flux of a conventional core and a core with shielding structures according to an example embodiment, which places three shielding bundles near the 45 degree azimuthal position of the core shroud. Referring to FIG. 3, the relative flux of a conventional core without shielding structures is plotted with the dark squares identified as “Base.” On the other hand, the relative flux of a core with shielding structures according to an example embodiment is plotted with the light circles identified as “ZrH₂.” As shown by FIG. 3, the core with shielding structures according to an example embodiment has a lower relative flux, particularly in the 30 to 60 degrees range. Notably, the relative flux at 45 degrees may be reduced by at least 50% (e.g., by at least 80%) with the shielding structures. By using the shielding structures disclosed herein, the fast neutron fluence may be reduced to below regulatory and/or desired levels so as to mitigate the degradation of structures such as a core shroud, thereby extending the operating life of a nuclear reactor.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A boiling water reactor core, comprising:
a core shroud;
a plurality of fuel bundles within the core shroud; and
a plurality of shielding bundles between the plurality of fuel bundles and the core shroud, the plurality of shielding bundles including a metal hydride.

2. The boiling water reactor core of claim 1, wherein the plurality of fuel bundles and the plurality of shielding bundles are arranged in an array within the core shroud, the plurality of shielding bundles being peripheral constituents of the array.

3. The boiling water reactor core of claim 2, wherein the peripheral constituents are outermost components of the array that are closest to the core shroud.

4. The boiling water reactor core of claim 1, wherein the plurality of shielding bundles include a water-proof sheath that surrounds the metal hydride.

5. The boiling water reactor core of claim 1, wherein each of the plurality of shielding bundles includes a plurality of shielding tubes containing the metal hydride, the plurality of shielding tubes having a same diameter as a plurality of fuel tubes containing nuclear fuel in the plurality of fuel bundles.

6. The boiling water reactor core of claim 1, wherein each of the plurality of shielding bundles is in a form of a single rod containing the metal hydride, the single rod having a greater diameter than each of a plurality of fuel tubes containing nuclear fuel in the plurality of fuel bundles.

7. The boiling water reactor core of claim 1, wherein the plurality of fuel bundles includes uranium dioxide.

8. The boiling water reactor core of claim 1, wherein the metal hydride is a transition metal hydride.

9. The boiling water reactor core of claim 8, wherein the transition metal hydride is a Group 4 metal hydride.

10. The boiling water reactor core of claim 9, wherein the Group 4 metal hydride is zirconium hydride or titanium hydride.

11. A method of reducing fast neutron fluence at a core shroud of a boiling water reactor, comprising:
surrounding a plurality of fuel bundles within the core shroud with a plurality of shielding bundles, the plurality of shielding bundles including a metal hydride.

12. The method of claim 11, wherein the surrounding includes inserting the plurality of shielding bundles between the core shroud and the plurality of fuel bundles.

13. The method of claim 11, wherein the plurality of fuel bundles are arranged in an array within the core shroud, and the surrounding includes replacing peripheral bundles of the plurality of fuel bundles with the plurality of shielding bundles.

14. The method of claim 11, wherein the plurality of fuel bundles are arranged in an array within the core shroud, and the surrounding includes replacing nuclear fuel in peripheral bundles of the plurality of fuel bundles with the metal hydride.

15. The method of claim 11, wherein the plurality of fuel bundles are arranged in an array within the core shroud, and the surrounding includes positioning the plurality of shielding bundles as outermost constituents of the array.

16. The method of claim 11, wherein the surrounding includes positioning the plurality of shielding bundles such that the plurality of shielding bundles do not contact the core shroud.

17. The method of claim 11, wherein the surrounding includes shielding the core shroud from fast neutrons originating from the plurality of fuel bundles.

18. The method of claim 11, wherein the metal hydride is zirconium hydride.
